(19) United States
(12) Patent Application Publication
(10) Pub. No.: US 2019/0240598 A1
(43) Pub. Date: Aug. 8, 2019

(54) LIQUID-COOLING DEVICE HAVING LIQUID-GAS ISOLATION MECHANISM

(71) Applicant: DELTA ELECTRONICS, INC., Taoyuan City (TW)

(72) Inventors: Meng-Sheng Chang, Taoyuan City (TW); Hui-Hsiung Wang, Taoyuan City (TW)

(21) Appl. No.: 16/042,438

(22) Filed: Jul. 23, 2018

(30) Foreign Application Priority Data
Feb. 2, 2018 (CN) 201810107150.0

(51) Int. Cl. B01D 19/00; F28F 23/02

(52) U.S. Cl. CPC B01D 19/0042; F28F 2265/18; F28F 23/02

(57) ABSTRACT

A liquid-cooling device having a liquid-gas isolation mechanism includes a tank, a first conduit, a second conduit, and a liquid-gas isolation mechanism. The tank has an outer wall, a first end, and a second end, and a liquid storage space is surrounded and defined by the outer wall, the first end, and the second end. The first conduit and the second conduit are partially disposed in the tank, and are respectively used for leading the cooling liquid in and out. The liquid-gas isolation mechanism includes at least a baffle disposed in the liquid storage space, and a plurality of flow holes are defined by the baffle and the outer wall. The first conduit, at least one flow hole, and the second conduit are configured as a flow path. Therefore, the gas is prevented from being brought out from the tank by the second conduit and entering the liquid-cooling pump.

### FIELD OF THE INVENTION

The present invention relates to a liquid-cooling device having a liquid-gas isolation mechanism, and more particularly to a liquid-cooling device of which the baffle is disposed in the liquid storage space to prevent gas from being brought out from the tank.

### BACKGROUND OF THE INVENTION

In high wattage products, such as projectors and other electronic products, due to their high heat generation, they often need to be equipped with heat dissipation devices, such as heat sinks or fans, in order to dissipate the heat of high wattage products. Since the heat dissipation efficiency of these heat dissipation devices is not high, liquid-cooling systems have been developed in the industry to dissipate heat more efficiently.

In prior arts, the liquid-cooling systems store the cooling liquid by the tank, and cooperate with the pipeline to drive the cooling liquid through the liquid-cooling pump in order to form a heat dissipating circulation in the pipeline, thereby dissipating the heat of the high wattage products. Furthermore, the water-cooling systems using water as cooling liquid are largely and widely used in the industry.

However, the cooling liquid in the tank may slowly evaporate from the pipeline with the using time, making the cooling liquid in the liquid-cooling system less and less and making the air volume become large. Furthermore, if the liquid cooling systems are used in projectors, since there is a requirement of installing the projector at any angle, the air is easily brought out after entering the tank under the coupling of the conditions of placing the projectors at different angles and evaporation of the cooling liquid. Under such circulation, the air may continue to enter and affect the liquid-cooling pump, or even cause damage to the liquid-cooling pump.

Therefore, there is a need of providing a liquid-cooling device having a liquid-gas isolation mechanism to solve the drawbacks in prior arts, prevent gas from being brought out from the tank to avoid air from entering the liquid-cooling pump causing damage to the liquid-cooling pump, and the air can still be left in the tank even if the tank is flipped arbitrarily.

### SUMMARY OF THE INVENTION

It is an object of the present invention to provide a liquid-cooling device to solve the drawbacks of prior arts. One or more embodiments of the present invention are described herein with notable technical features.

By disposing the liquid-gas isolation mechanism, the gas is prevented from being brought out by the second conduit and entering the liquid-cooling pump, so that the damage of the liquid-cooling pump is avoided.

Through disposing the baffle in the liquid storage space and defining a plurality of flow holes by the baffle and the outer wall, the gas may be left in the tank while the cooling liquid is led out from the tank, such that the air is prevented from entering the liquid-cooling pump.

By disposing the baffle having protrusions and cooperating with the pipeline, the air may still be left in the tank while the liquid-cooling device is flipped and set, so as to prevent the air from entering the liquid-cooling pump and avoid the damage.

Through disposing the partition corresponding to the inlet end, the flow passage is defined by the partition and the outer wall, and matched with the baffles and the pipeline, so as to avoid the gas from being brought out from the tank while the cooling liquid is led out, such that the air is prevented from entering the liquid-cooling pump.

In accordance with an aspect of the present invention, there is provided a liquid-cooling device having a liquid-gas isolation mechanism. The liquid-cooling device comprises a tank, a first conduit, a second conduit, and the liquid-gas isolation mechanism. The tank has an outer wall, a first end, and a second end. The first end is opposite to the second end, and a liquid storage space for accommodating a cooling liquid is surrounded and defined by the outer wall, the first end, and the second end. The first conduit is partially disposed in the tank for leading the cooling liquid in. The second conduit partially disposed in the tank for leading the cooling liquid out. The liquid-gas isolation mechanism is configured to prevent gas from being led out by the second conduit, and comprises at least a baffle. The baffle is disposed in the liquid storage space, and a plurality of flow holes are defined by the baffle and the outer wall. The first conduit, at least one of the flow holes, and the second conduit are configured as a flow path.

In accordance with an aspect of the present invention, there is provided a liquid-gas isolation device for separating the gas from the cooling liquid. The liquid-gas isolation device comprises a tank, a first conduit, a second conduit, at least one baffle, and a plurality of flow holes. The tank has an outer wall, which defines a storage space for accommodating the cooling liquid. The first conduit is in fluid communication with the storage space and configured to guide a flow of the cooling liquid into the storage space. The second conduit is in fluid communication with the storage space and configured to guide a flow of the cooling liquid out of the storage space. The baffle is disposed in the liquid storage space and configured to allow a guidance of a flow of the cooling liquid in the storage space. The plurality of flow holes are defined by the baffle and the outer wall. The first conduit, at least one of the flow holes, and the second conduit are configured to provide a flow path for the cooling liquid. The flow path extends distal to the first conduit and the second conduit to effect the separation of the gas from the cooling liquid when the cooling liquid flows via the flow path.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a liquid-cooling device having a liquid-gas isolation mechanism according to an embodiment of the present invention;

FIG. 2 schematically illustrates another view of the liquid-cooling device having a liquid-gas isolation mechanism as shown in FIG. 1;

FIG. 3 schematically illustrates the liquid-cooling device having a liquid-gas isolation mechanism as shown in FIG. 1 after being flipped;

FIG. 4 schematically illustrates a liquid-cooling device having a liquid-gas isolation mechanism according to another embodiment of the present invention;

FIG. 5 schematically illustrates a liquid-cooling device having a liquid-gas isolation mechanism according to another embodiment of the present invention;

FIG. 6 schematically illustrates another view of the liquid-cooling device having a liquid-gas isolation mechanism as shown in FIG. 5;

FIG. 7 schematically illustrates the liquid-cooling device having a liquid-gas isolation mechanism as shown in FIG. 5 after being flipped;

FIG. 8 schematically illustrates a liquid-cooling device having a liquid-gas isolation mechanism according to another embodiment of the present invention;

FIG. 9 schematically illustrates a liquid-cooling device having a liquid-gas isolation mechanism according to another embodiment of the present invention;

FIG. 10 schematically illustrates a liquid-cooling device having a liquid-gas isolation mechanism according to another embodiment of the present invention;

FIG. 11 schematically illustrates a liquid-cooling device having a liquid-gas isolation mechanism according to another embodiment of the present invention;

FIG. 12 schematically illustrates a liquid-cooling device having a liquid-gas isolation mechanism according to another embodiment of the present invention; and

FIG. 13 schematically illustrates a liquid-cooling device having a liquid-gas isolation mechanism according to another embodiment of the present invention.

FIG. 14 schematically illustrates a liquid-gas isolation device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

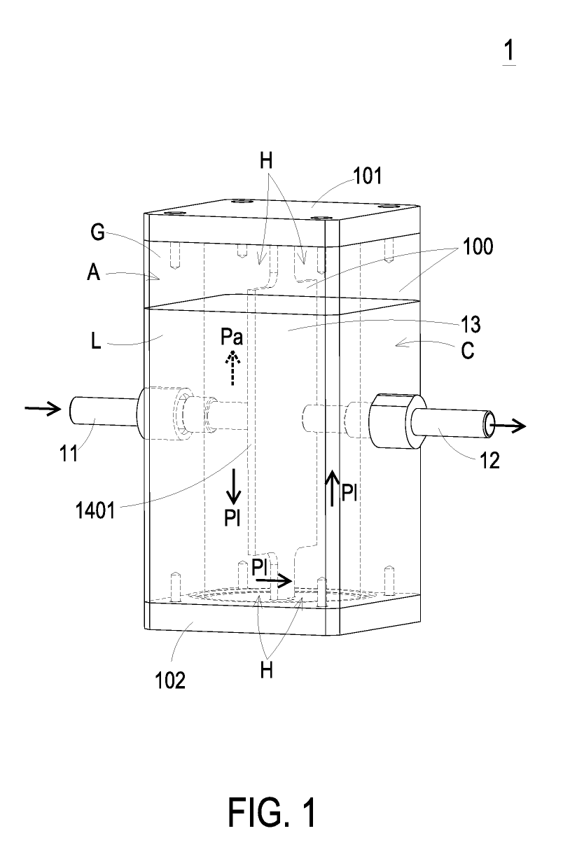

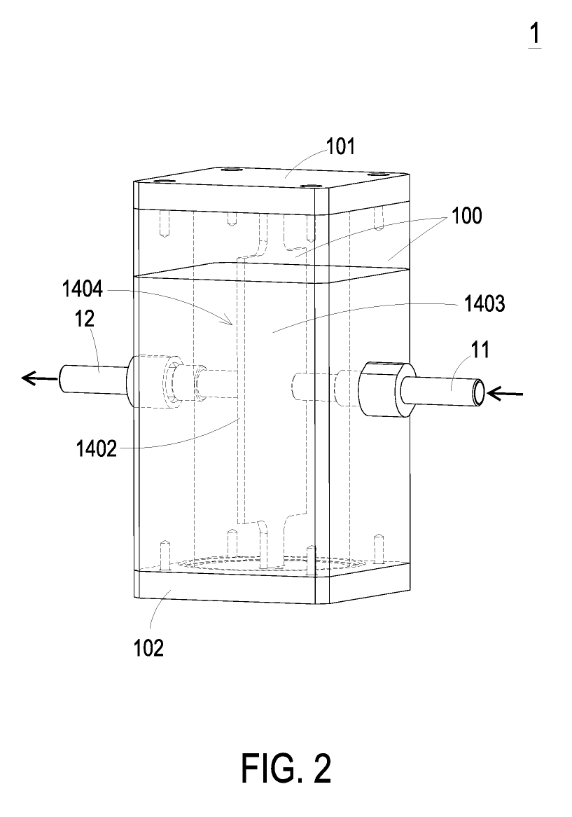

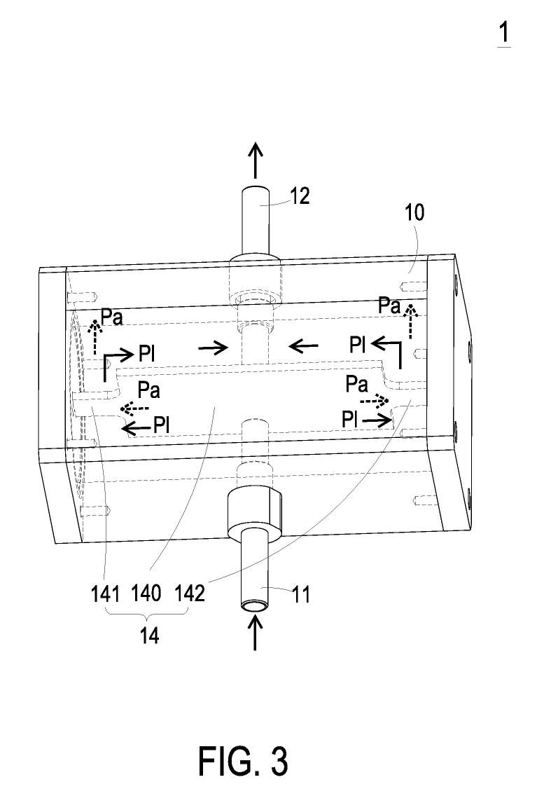

Please refer to FIG. 1, FIG. 2, and FIG. 3. FIG. 1 schematically illustrates a liquid-cooling device having a liquid-gas isolation mechanism according to an embodiment of the present invention. FIG. 2 schematically illustrates another view of the liquid-cooling device having a liquid-gas isolation mechanism as shown in FIG. 1. FIG. 3 schematically illustrates the liquid-cooling device having a liquid-gas isolation mechanism as shown in FIG. 1 after being flipped. As shown in FIG. 1, FIG. 2, and FIG. 3, the liquid-cooling device 1 having a liquid-gas isolation mechanism comprises a tank 10, a first conduit 11, a second conduit 12, and a liquid-gas isolation mechanism 13, among which the liquid-cooling device 1 may be a water-cooling device applied in projectors, and the tank 10 may be a hexahedron tank or a cylinder tank, but not limited herein.

The tank 10 has an outer wall 100, a first end 101, and a second end 102. The first end 101 is opposite to the second end 102, and a liquid storage space C is surrounded and defined by the outer wall 100, the first end 101, and the second end 102 for accommodating cooling liquid L. The first conduit 11 is partially disposed in the tank 10 for leading the cooling liquid L in, and the second conduit 12 is partially disposed in the tank for leading the cooling liquid L out. For example, parts of the first conduit 11 and the second conduit 12 are disposed in the liquid storage space C, the other parts of the first conduit 11 and the second conduit 12 are disposed outside the tank 10, and through a liquid-cooling pump, the cooling liquid L is led into the tank 10 through the first conduit 11 and led out of the tank 10 through the second conduit 12, but not limited thereto.

The liquid-gas isolation mechanism 13 is configured to prevent gas G from being led out by the second conduit 12, and the liquid-gas isolation mechanism 13 comprises at least a baffle 14. The baffle 14 is disposed in the liquid storage space C, and a plurality of flow holes H are defined by the baffle 14 and the outer wall 100. The first conduit 11, at least one of the flow holes H, and the second conduit 12 are configured as a flow path Pl.

The liquid storage space C further comprises a gas space A. After the gas G is led in the liquid storage space C along with the cooling liquid L, the gas G is concentrated toward the gas space A along an gas flow path Pa, and after the cooling liquid L is led in the liquid storage space C, the cooling liquid L is led out toward the second conduit 12 along the flow path Pl, among which the second conduit 12 is disposed at a distance from the gas space A. Therefore, the gas G is concentrated toward the gas space A by the flow path Pl of the cooling liquid L and the buoyant force, and the gas G is prevented from being brought out from the tank 10 through the second conduit 12.

In other words, in the liquid-cooling device having a liquid-gas isolation mechanism of the present invention, by disposing the liquid-gas isolation mechanism, the gas is prevented from being brought out from the tank by the second conduit. Furthermore, through disposing the baffle in the liquid storage space and defining a plurality of flow holes by the baffle and the outer wall, the gas may be left in the tank while the cooling liquid is led out from the tank, such that the air is prevented from entering the liquid-cooling pump, and the damage of the liquid-cooling pump is avoided. It should be noted that the gas space is a predetermined space where the gas is concentrated by inertia and buoyancy along the gas flow path after the tank is flipped. In addition, the gas space shown on each of the drawings is drawn for ease of description, and the actual size of the gas space varies depending on the amount of gas contained or generated by the entirety of liquid-cooling device.

In some embodiments, the first conduit 11 and the second conduit 12 are penetrated through the outer wall 100, and the liquid-gas isolation mechanism 13 comprises a baffle 14 disposed between the first conduit 11 and the second conduit 12. In some embodiments, the baffle 14 has a main body 140, a first protrusion 141, and a second protrusion 142. The first protrusion 141 and the second protrusion 142 are extended from the main body 140, for example but not limited to being disposed symmetrically with respect to the main body 140, and the first protrusion 141 and the second protrusion 142 are respectively connected with the first end 101 and the second end 102. Furthermore, the plurality of flow holes H are defined by the main body 140, the first protrusion 141, the second protrusion 142, and the outer wall 100.

For example, two flow holes H are defined by the main body 140 and the first protrusion 141 of the baffle 14 and the outer wall 100, and the two flow holes H are, for example but not limited to, symmetrical to the first protrusion 141. Furthermore, two flow holes H are defined by the main body 140, the second protrusion 142, and the outer wall 100, and the two flow holes H are, for example but not limited to, symmetrical to the second protrusion 142. Therefore, the cooling liquid L is led in the tank 10, flow through the flow holes H, and is led out from the tank 10 along the flow path Pl.

In some embodiments, the main body 140 of the baffle 14 has a first side surface 1401 and a second side surface 1402 opposite to the first side surface 1401, and the first side surface 1401 and the second side surface 1402 are fully contacted with the outer wall 100. That is to say, the first side surface 1401 and the second side surface 1402 are flatly contacted with the outer wall 100 to prevent the gas G from leaking from the periphery of the main body 140 and being brought out from the tank 10.

As shown in FIG. 1, when the first conduit 11 and the second conduit 12 are disposed substantially in the left and right direction, the cooling liquid L is led in the tank 10 through the first conduit 11 along the flow path Pl by the liquid-cooling pump and moved toward the second end 102 of the tank 10. Then, the cooling liquid L flows through the flow holes H defined by the main body 140, the second protrusion 142, and the outer wall 100, and is led out from the tank 10 through the second conduit 12. The gas G is moved toward the first end 101 of the tank 10 along the flow path Pa, and reached the liquid level of the cooling liquid L, thereby leaving the gas G in the tank 10 to prevent the gas G from being brought out form the tank 10 through the second conduit 12. It should be noted that, in the present invention, the opening of the second conduit 12 disposed in the tank 10 should be permanently immersed under the liquid level of the cooling liquid L.

When the tank 10 is flipped to a specific angle, making the first conduit 11 and the second conduit 12 dispose substantially in the up and down direction, the cooling liquid L is led in the tank 10 through the first conduit 11 along the flow path Pl by the liquid-cooling pump. Then, the cooling liquid L flows through the flow holes H defined by the main body 140, the first protrusion 141, the second protrusion 142, and the outer wall 100, and is led out from the tank 10 through the second conduit 12. The gas G is moved toward the flow holes H along the flow path Pa, and reached the liquid level of the cooling liquid L, thereby leaving the gas G in the tank 10 to prevent the gas G from being brought out form the tank 10 through the second conduit 12.

In some embodiments, the main body 140 of the baffle 14 has a first surface 1403 and a second surface 1404 on two different sides of the main body 140. The first conduit 11 is disposed adjacent to the first surface 1403, and the second conduit 12 is disposed adjacent to the second surface 1404. The first conduit 11 is perpendicular to the first surface 1403 of the baffle 14, and the second conduit 12 is perpendicular to the second surface 1404 of the baffle 14 (as shown in FIG. 1), but not limited herein.

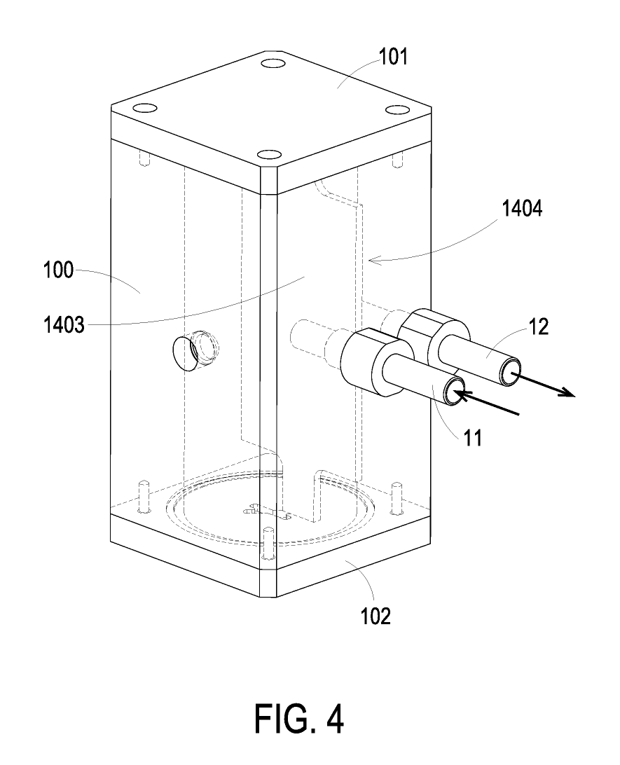

Please refer to FIG. 4, and cooperate with FIG. 1, FIG. 2 and FIG. 3. FIG. 4 schematically illustrates a liquid-cooling device having a liquid-gas isolation mechanism according to another embodiment of the present invention. In some embodiments, the first conduit 11 is disposed adjacent to the second conduit 12, the first conduit 11 is parallel to the first surface 1403 of the baffle 14, and the second conduit 12 is parallel to the second surface 1404 of the baffle 14 (as shown in FIG. 4), but not limited thereto.

In brief, in the liquid-cooling device having a liquid-gas isolation mechanism of the present invention, by disposing the baffle having protrusions between the first conduit and the second conduit, the air may still be left in the tank while the liquid-cooling device is flipped and set, so as to prevent the air from entering the liquid-cooling pump and avoid the damage.

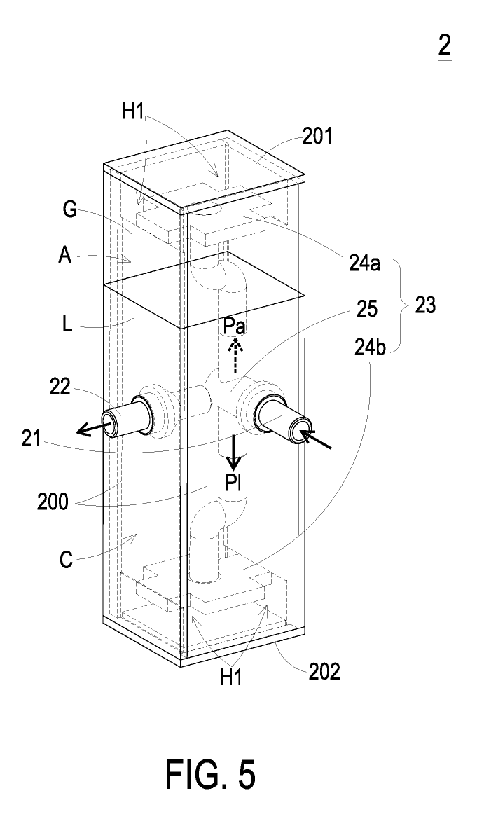

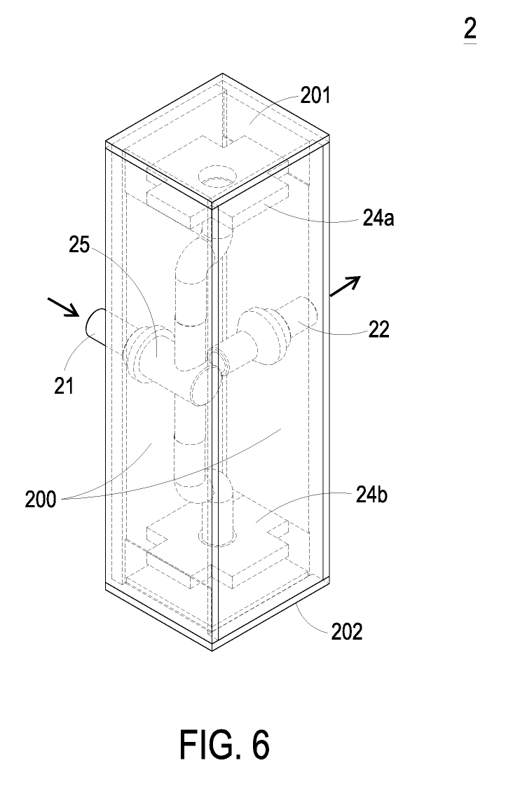

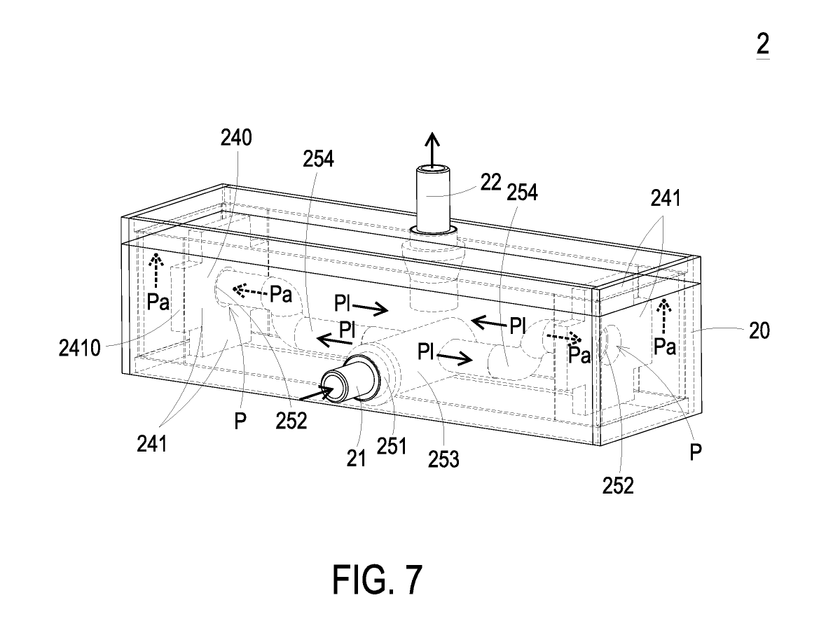

Please refer to FIG. 5, FIG. 6, and FIG. 7. FIG. 5 schematically illustrates a liquid-cooling device having a liquid-gas isolation mechanism according to another embodiment of the present invention. FIG. 6 schematically illustrates another view of the liquid-cooling device having a liquid-gas isolation mechanism as shown in FIG. 5. FIG. 7 schematically illustrates the liquid-cooling device having a liquid-gas isolation mechanism as shown in FIG. 5 after being flipped. As shown in FIG. 5, FIG. 6, and FIG. 7, the liquid-cooling device 2 having a liquid-gas isolation mechanism comprise a tank 20, a first conduit 21, a second conduit 22, and a liquid-gas isolation mechanism 23, among which the liquid-cooling device 2 may be a water-cooling device applied in projectors, but not limited herein.

The tank 20 has a liquid storage space C to accommodate the cooling liquid L, and the first conduit 21 and the second conduit 22 are penetrated through the outer wall 200 of the tank 20, among which the first conduit 21 and the second conduit 22 are partially disposed in the tank 20. For example, parts of the first conduit 21 and the second conduit 22 are disposed in the liquid storage space C, the other parts of the first conduit 21 and the second conduit 22 are disposed outside the tank 20, and through a liquid-cooling pump, the cooling liquid L is led into the tank 20 through the first conduit 21 and led out of the tank 20 through the second conduit 22, but not limited thereto.

The liquid-gas isolation mechanism 23 is configured to prevent gas G from being led out by the second conduit 22, and the liquid-gas isolation mechanism 23 comprises a first baffles 24a, a second baffle 24b and an internal conduit 25. The first baffle 24a is disposed at the first end 201 and the second baffle 24b is disposed at the second end 202 of the tank 20. Each of the first baffle 24a and the second baffle 24b has a perforation P, and the plurality of flow holes H1 are defined by each of the first baffle 24a and the second baffle 24b and the outer wall 200 of the tank 20. The internal conduit 25 has a first opening 251 and two second openings 252. The first opening 251 is communicated with the first conduit 21, one of the second openings 252 is communicated with the perforation P of the first baffle 24a, and the other one of the second openings 252 is communicated with the perforation P of the second baffle 24b, among which the perforation P of the first baffle 24a is on the center of the first baffle 24a, and the perforation of the second baffle 24b is on the center of the second baffle 24b, but not limited herein. The first conduit 21, the internal conduit 25, at least one of the flow holes H1, and the second conduit 22 are configured as a flow path Pl.

The liquid storage space C further comprises a gas space A. After the gas G is led in the liquid storage space C along with the cooling liquid L, the gas G is concentrated toward the gas space A along an gas flow path Pa, and after the cooling liquid L is led in the liquid storage space C, the cooling liquid L is led out toward the second conduit 22 along the flow path Pl, among which the second conduit 22 is disposed at a distance from the gas space A. Therefore, the gas G is concentrated toward the gas space A by the flow path Pl of the cooling liquid L and the buoyant force, and the gas G is prevented from being brought out from the tank 20 through the second conduit 22.

In some embodiments, the internal conduit 25 further has a middle portion 253 and two extension portions 254. The extension portions 254 are communicated with two sides of the middle portion 253, and the extension portions 254 respectively have the second openings 252 to communicate with the perforations P. In some embodiment, the first baffle 24a and one of the extension portions 254 are symmetric to the second baffle 24b and the other one of the extension portions 254 relative to the middle portion 253, but not limited herein.

Each of the first baffle 24a and the second baffle 24b has a main body 240 and a plurality of protrusions 241. The plurality of protrusions 241 are extended from the main body 240, and the plurality of flow holes H1 are defined by the main body 240, the plurality of protrusions 241 and the outer wall 200. In some embodiment, the plurality of protrusions 241 are disposed symmetrically with respect to the perforation P, but not limited thereto.

In some embodiment, each of the first baffle 24a and the second baffle 24b has four protrusions 241, and each of the protrusions 241 has a side surface 2410 fully contacted with the outer wall 200. That is to say, the protrusions 241 are flatly contacted with the outer wall 200 to prevent the gas G from leaking from the periphery of the main body 240 and being brought out from the tank 20.

When the distance between the first conduit 21 and the ground is substantially equal to the distance between the second conduit 22 and the ground, the cooling liquid L is led in the tank 20 through the first conduit 21 along the flow path Pl by the liquid-cooling pump and moved toward the perforation P of the second baffle 24b disposed at the second end 202 through the internal conduit 25. Then, the cooling liquid L flows through the flow holes H1 defined by the protrusions 241 of the first baffle 24a and the outer wall 200, and is led out from the tank 20 through the second conduit 22. The gas G is moved toward the perforation P of the first baffle 24a disposed at the first end 201 through the internal conduit 25 along the flow path Pa, and reached the liquid level of the cooling liquid L, thereby leaving the gas G in the tank 20 to prevent the gas G from being brought out form the tank 20 through the second conduit 22. It should be noted that, in the present invention, the opening of the second conduit 22 disposed in the tank 20 should be permanently immersed under the liquid level of the cooling liquid L.

When the tank 20 is flipped to a specific angle, making the first conduit 21 closest to the ground compared to the tank 20 and the second conduit 22, the cooling liquid L is led in the tank 20 through the first conduit 21 along the flow path Pl by the liquid-cooling pump, moved toward the perforations P of the first baffle 24a and the second baffle 24b through the internal conduit 25. Then, the cooling liquid L flows through the flow holes H1 defined by the main body 240, the protrusions 241 of the first baffle 24a and the second baffle 24b, and the outer wall 200, and is led out from the tank 20 through the second conduit 12. The gas G is moved toward the perforations P of the first baffle 24a and the second baffle 24b through the internal conduit 25 along the flow path Pa, and reached the liquid level of the cooling liquid L, thereby leaving the gas G in the tank 20 to prevent the gas G from being brought out form the tank 20 through the second conduit 22.

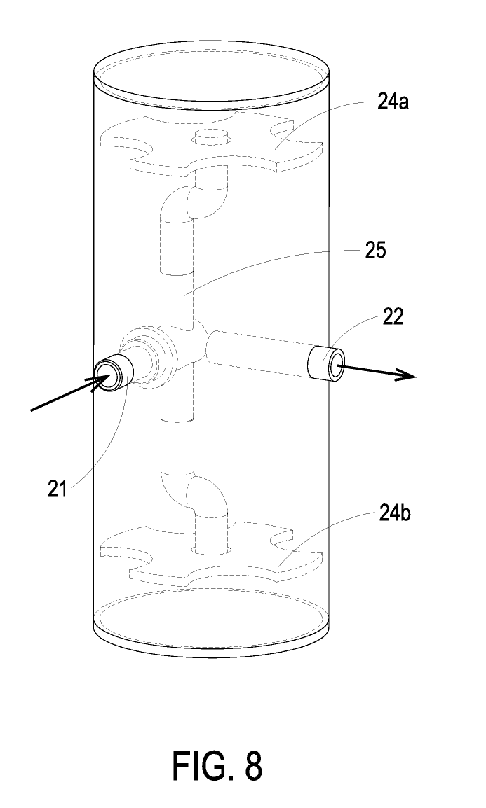

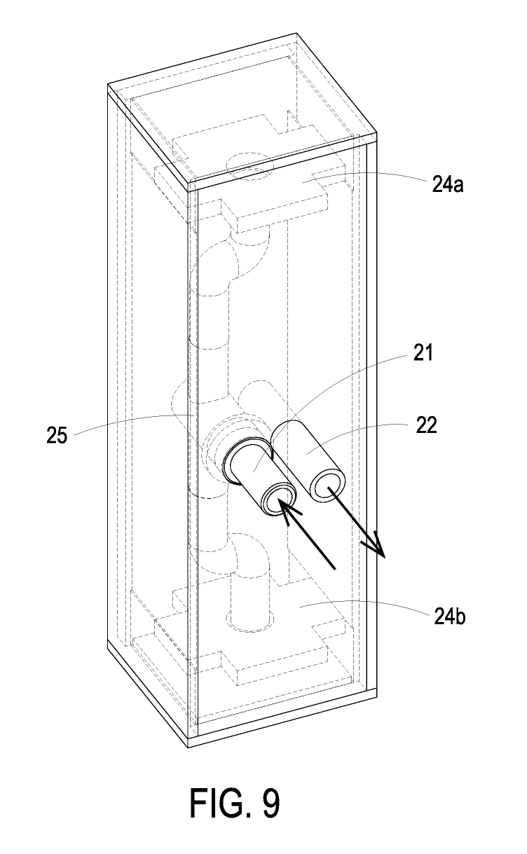

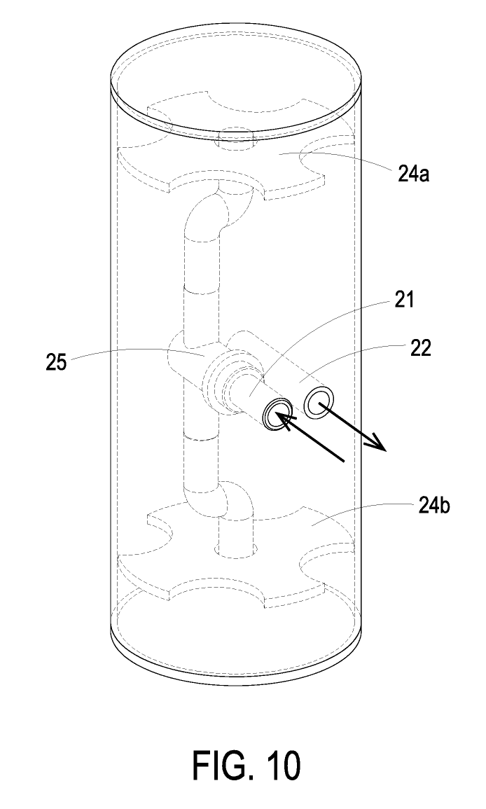

Please refer to FIG. 8, FIG. 9, and FIG. 10, and cooperate with FIG. 5, FIG. 6 and FIG. 7. FIG. 8 schematically illustrates a liquid-cooling device having a liquid-gas isolation mechanism according to another embodiment of the present invention. FIG. 9 schematically illustrates a liquid-cooling device having a liquid-gas isolation mechanism according to another embodiment of the present invention. FIG. 10 schematically illustrates a liquid-cooling device having a liquid-gas isolation mechanism according to another embodiment of the present invention. In some embodiment, the first conduit 21 of the liquid-cooling device 2 is perpendicular to the second conduit 22, and the first conduit 21 and the second conduit 22 are penetrated through the outer wall 200 of the tank 20, among which the tank may be a hexahedron tank (as shown in FIG. 5) or a cylinder tank (as shown in FIG. 8). In some embodiment, the first conduit 21 is disposed adjacent to the second conduit 22, the first conduit 21 is parallel to the second conduit 22, and the first conduit 21 and the second conduit 22 are penetrated through the outer wall 200 of the tank 20, among which the tank 20 may be a hexahedron tank (as shown in FIG. 9) or a cylinder tank (as shown in FIG. 10).

In brief, in the liquid-cooling device having a liquid-gas isolation mechanism of the present invention, by disposing the baffles having protrusions and perforations at the ends of the tank and cooperating with the pipeline, the air may still be left in the tank while the liquid-cooling device is flipped and set, so as to prevent the air from entering the liquid-cooling pump and avoid the damage.

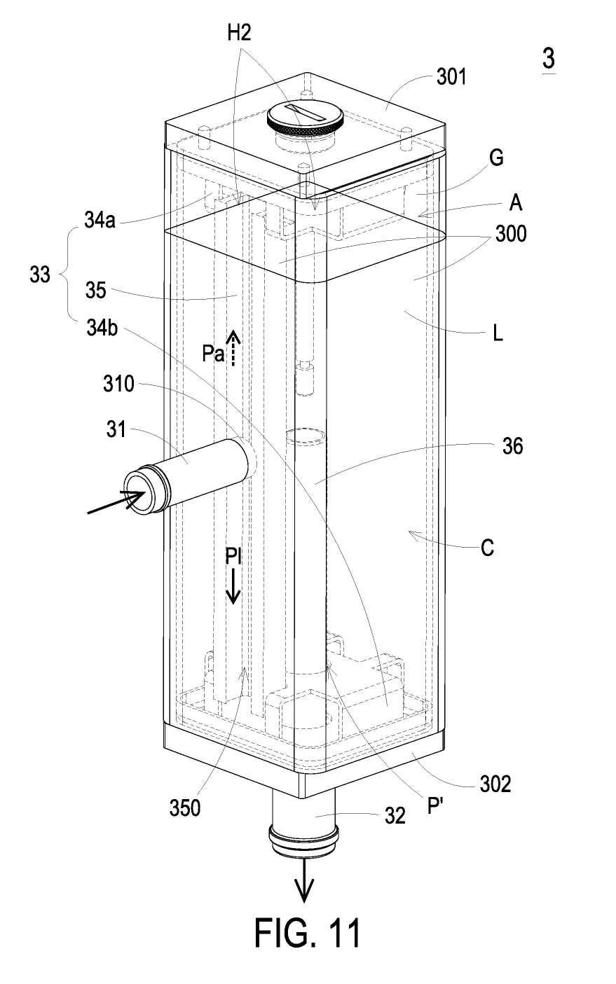

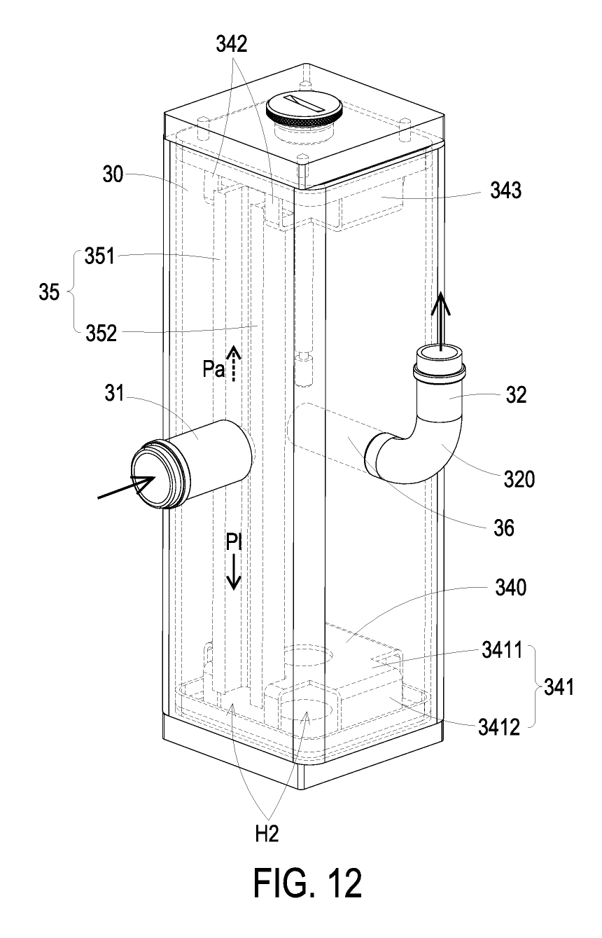

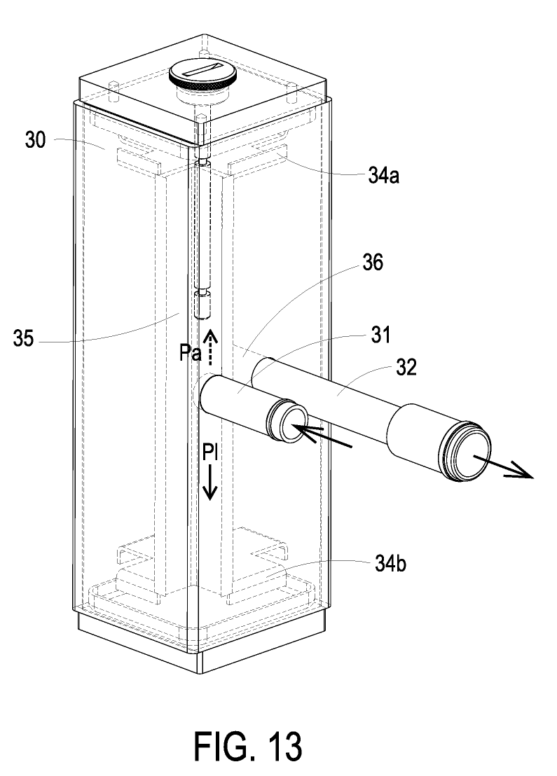

Please refer to FIG. 11, FIG. 12, and FIG. 13. FIG. 11 schematically illustrates a liquid-cooling device having a liquid-gas isolation mechanism according to another embodiment of the present invention. FIG. 12 schematically illustrates a liquid-cooling device having a liquid-gas isolation mechanism according to another embodiment of the present invention. FIG. 13 schematically illustrates a liquid-cooling device having a liquid-gas isolation mechanism according to another embodiment of the present invention. As shown in FIG. 11, FIG. 12, and FIG. 13, the liquid-cooling device 3 having a liquid-gas isolation mechanism comprises a tank 30, a first conduit 31, a second conduit 32, and a liquid-gas isolation mechanism 33, among which the liquid-cooling device 3 may be a water-cooling device applied in projectors, but not limited herein.

The first conduit 31 is penetrated through the outer wall 300 of the tank 30, the first conduit 31 and the second conduit 32 are partially disposed in the tank 30, and the first conduit 31 has an inlet end 310 disposed in the tank 30. The liquid-gas isolation mechanism 33 comprises a first baffle 34a, a second baffle 34b and a partition 35. The first baffle 34a is disposed at the first end 301 and second baffle 34b is disposed at the second end 302. The flow holes H2 at the first end 301 are defined by the first baffle 34a and the outer wall 300 of the tank 30, and the flow holes H2 at the second end 302 are defined by the second baffle 34b and the outer wall 300 of the tank 30. The partition 35 is disposed corresponding to the inlet end 310, one of the flow holes H2 of each of the first baffle 34a and the second baffle 34b is communicated with the partition 35, and a flow passage 350 is defined by the partition 35 and the outer wall 300. The first conduit 31, the flow passage 350, at least one of the flow holes H2, and the second conduit 32 are configured as a flow path Pl. Therefore, the cooling liquid L is led in the tank 30 through the first conduit 31, moved forward along the flow path Pl, and led out from the tank 20 through the second conduit 21. The gas G is moved toward the first end 301 of the tank 30 along the gas flow path Pa, reached the liquid level of the cooling liquid L, so that the gas G is left in the tank 30, thereby preventing the gas G from being brought out from the tank 30 through the second conduit 32.

The liquid storage space C further comprises a gas space A. After the gas G is led in the liquid storage space C along with the cooling liquid L, the gas G is concentrated toward the gas space A along an gas flow path Pa, and after the cooling liquid L is led in the liquid storage space C, the cooling liquid L is led out toward the second conduit 32 along the flow path Pl, among which the second conduit 32 is disposed at a distance from the gas space A. Therefore, the gas G is concentrated toward the gas space A by the flow path Pl of the cooling liquid L and the buoyant force, and the gas G is prevented from being brought out from the tank 30 through the second conduit 32.

In some embodiment, the partition 35 has a first side surface 351 and a second side surface 352, and the first side surface 351 and the second side surface 352 are fully contacted with the outer wall 300. That is to say, the first side surface 351 and the second side surface 352 of the partition 35 are flatly contacted with the outer wall 300, respectively, so as to prevent the gas G from leaking from the periphery of the flow passage 350 and being brought out from the tank 10.

In some embodiments, each of the first baffle 34a and the second baffle 34b has a main body 340 and a plurality of protrusions 341, the plurality of protrusions 341 are extended from the main body 340, and the plurality of flow holes H2 are defined by the main body 340, the plurality of protrusions 341 and the outer wall 300. The plurality of protrusions 341 for example but not limited to be disposed symmetrically with respect to the main body 340. In some embodiments, each of the protrusions 341 has a first body 3411 and a second body 3412, the first body 3411 is extended from the main body 340, and the second body 3412 is perpendicular to the first body 3411, among which the main body 340 and the first body 3411 and the second body 3412 of the protrusion 341 may be a one-piece formed structure, but not limited herein.

In some embodiments, the partition 35 is connected with the main body 340 and two of the protrusions 341 of each of the first baffle 34a and the second baffle 34b, such that the flow passage 350 is defined by the partition 35 and the outer wall 300. In some embodiment, the plurality of protrusions 241 comprises at least two first protrusions 342 and a plurality of second protrusions 343, and the partition 35 is connected with the main body 240 and the first protrusions 342 of each of the first baffle 34a and the second baffle 34b, among which the width of each of the first protrusions 342 is smaller than the width of each of the second protrusions 343. The partition may be a one-piece formed L-shaped or U-shaped partition, but not limited herein.

In some embodiments, the liquid cooling device 3 further comprises an internal conduit 36. One end of the internal conduit 36 is communicated with the second conduit 32, and the other end of the internal conduit 36 is extended in the liquid storage space C. In some embodiments, the first conduit 31 is penetrated through the outer wall 300, and the internal conduit 36 is disposed perpendicular to the first conduit. Furthermore, each of the first baffle 34a and the second baffle 34b has a perforation P′, the second conduit 32 is penetrated through the second end 302 of the tank 30, and the internal conduit 36 is penetrated through the perforation P′ of the second baffle 34b disposed at the second end 302 (as shown in FIG. 11), but not limited thereto.

In some embodiments, the first conduit 31 is penetrated through the outer wall 300, the internal conduit 36 is disposed perpendicular to the first conduit 31, and the second conduit 32 is penetrated through the outer wall 300 and communicated with the internal conduit 36, among which the second conduit 32 has a curved portion 320 (as shown in FIG. 12), but not limited herein. In some embodiments, the first conduit 31 and the second conduit are penetrated through the outer wall 300, the first conduit 31 is disposed adjacent to the second conduit 32, and the second conduit 32 and the internal conduit 36 are disposed parallel to the first conduit 31 (as shown in FIG. 13), but not limited herein.

In other words, in the liquid-cooling device having a liquid-gas isolation mechanism of the present invention, through disposing the partition corresponding to the inlet end, the flow passage is defined by the partition and the outer wall, and matched with the baffles and the pipeline, so as to avoid the gas from being brought out from the tank while the cooling liquid is led out, such that the air is prevented from entering the liquid-cooling pump.

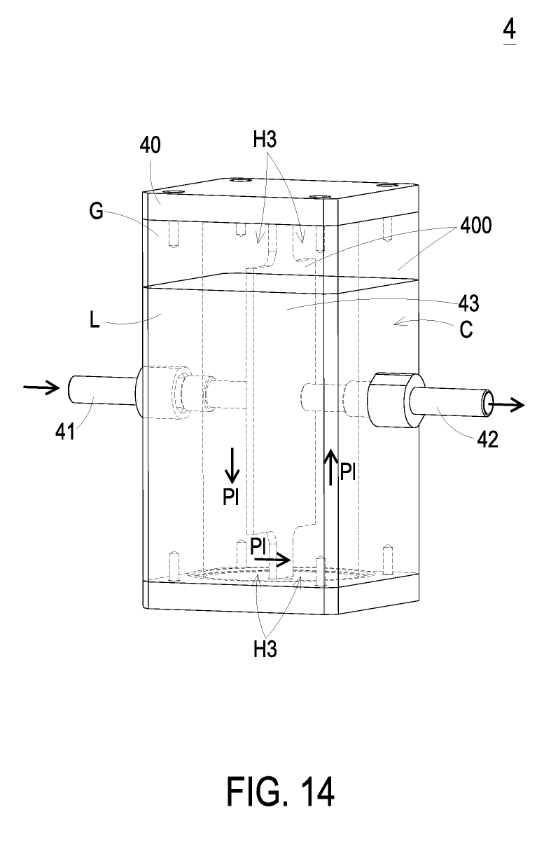

Please refer to FIG. 14, which schematically illustrates a liquid-gas isolation device according to an embodiment of the present invention. As shown in FIG. 14, in some embodiments, the liquid-gas isolation device 4 for separating the gas G from the cooling liquid L comprises a tank 40, a first conduit 41, a second conduit 42, at least one baffle 43, and a plurality of flow holes H3. The tank 40 has an outer wall 400, which defines a storage space C for accommodating the cooling liquid L. The first conduit 41 is in fluid communication with the storage space C and configured to guide a flow of the cooling liquid L into the storage space C. The second conduit 42 is in fluid communication with the storage space C and configured to guide a flow of the cooling liquid L out of the storage space C.

The baffle 43 is disposed in the liquid storage space C and configured to allow a guidance of a flow of the cooling liquid L in the storage space C. For example, as shown in FIG. 14, the cooling liquid L may be guided to flow in the storage space C in the direction of a flow path Pl alongside one side of the baffle 43; or through an opening (flow hole) H3 of the baffle 43; or alongside another side of the baffle 43. In this example, the baffle 43 act as a type of obstacle to obstruct direct-line flow of cooling liquid L from the first conduit 41 to the second conduit 42, such that the cooling liquid L flow in the storage space C may be guided to flow corresponding to the placement or configuration of the baffle 43.

The plurality of flow holes H3 are defined by the baffle 43 and the outer wall 100. The first conduit 41, at least one of the flow holes H3, and the second conduit 42 are configured to provide a flow path Pl for the cooling liquid L. The flow path Pl extends distal to the first conduit 41 and the second conduit 42 to effect the separation of the gas G from the cooling liquid L when the cooling liquid L flows via the flow path Pl, but not limited herein.

From the above description, the present disclosure provides a liquid-cooling device having a liquid-gas isolation mechanism. By disposing the liquid-gas isolation mechanism, the gas is prevented from being brought out by the second conduit and entering the liquid-cooling pump, so that the damage of the liquid-cooling pump is avoided. Furthermore, through disposing the baffle in the liquid storage space and defining a plurality of flow holes by the baffle and the outer wall, the gas may be left in the tank while the cooling liquid is led out from the tank, such that the air is prevented from entering the liquid-cooling pump. Moreover, by disposing the baffle having protrusions and cooperating with the pipeline, the air may still be left in the tank while the liquid-cooling device is flipped and set, so as to prevent the air from entering the liquid-cooling pump and avoid the damage. Meanwhile, through disposing the partition corresponding to the inlet end, the flow passage is defined by the partition and the outer wall, and matched with the baffles and the pipeline, so as to avoid the gas from being brought out from the tank while the cooling liquid is led out, such that the air is prevented from entering the liquid-cooling pump.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A liquid-cooling device having a liquid-gas isolation mechanism, comprising:
a tank having an outer wall, a first end, and a second end, wherein the first end is opposite to the second end, and a liquid storage space for accommodating a cooling liquid is surrounded and defined by the outer wall, the first end, and the second end;
a first conduit disposed in the tank for leading the cooling liquid in;
a second conduit partially disposed in the tank for leading the cooling liquid out; and
the liquid-gas isolation mechanism configured to prevent gas from being led out by the second conduit, comprising:
at least a baffle disposed in the liquid storage space, wherein a plurality of flow holes are defined by the baffle and the outer wall,
wherein the first conduit, at least one of the flow holes, and the second conduit are configured as a flow path.

2. The liquid-cooling device having the liquid-gas isolation mechanism according to claim 1, wherein the liquid storage space further comprises a gas space, wherein after the gas is led in the liquid storage space along with the cooling liquid, the gas is concentrated toward the gas space along a gas flow path, and after the cooling liquid is led in the liquid storage space, the cooling liquid is led out toward the second conduit along the flow path, and wherein the second conduit is disposed at a distance from the gas space.

3. The liquid-cooling device having the liquid-gas isolation mechanism according to claim 1, wherein the first conduit and the second conduit are penetrated through the outer wall, the liquid-gas isolation mechanism comprises a baffle, and the baffle is disposed between the first conduit and the second conduit.

4. The liquid-cooling device having the liquid-gas isolation mechanism according to claim 3, wherein the baffle has a main body, a first protrusion, and a second protrusion, the first protrusion and the second protrusion are extended from the main body, and the first protrusion and the second protrusion are respectively connected with the first end and the second end.

5. The liquid-cooling device having the liquid-gas isolation mechanism according to claim 4, wherein the plurality of flow holes are defined by the main body, the first protrusion, the second protrusion, and the outer wall.

6. The liquid-cooling device having the liquid-gas isolation mechanism according to claim 5, wherein the main body has a first side surface and a second side surface opposite to the first side surface, and the first side surface and the second side surface are fully contacted with the outer wall.

7. The liquid-cooling device having the liquid-gas isolation mechanism according to claim 4, wherein the main body of the baffle has a first surface and a second surface on two different sides of the main body, the first conduit is disposed adjacent to the first surface, and the second conduit is disposed adjacent to the second surface.

8. The liquid-cooling device having the liquid-gas isolation mechanism according to claim 7, wherein the first conduit is perpendicular to the first surface of the baffle, and the second conduit is perpendicular to the second surface of the baffle.

9. The liquid-cooling device having the liquid-gas isolation mechanism according to claim 7, wherein the first conduit is disposed adjacent to the second conduit, the first conduit is parallel to the first surface of the baffle, and the second conduit is parallel to the second surface of the baffle.

10. The liquid-cooling device having the liquid-gas isolation mechanism according to claim 1, wherein the first conduit and the second conduit are penetrated through the outer wall, and the liquid-gas isolation mechanism comprises:
a first baffle disposed at the first end and a second baffle disposed at the second end, wherein each of the first baffle and the second baffle has a perforation, and the plurality of flow holes are defined by each of the first baffle and the second baffle and the outer wall of the tank; and
an internal conduit having a first opening and two second openings, wherein the first opening is communicated with the first conduit, one of the second openings is communicated with the perforation of the first baffle, and the other one of the second openings is communicated with the perforation of the second baffle;
wherein the first conduit, the internal conduit, at least one of the flow holes, and the second conduit are configured as a flow path.

11. The liquid-cooling device having the liquid-gas isolation mechanism according to claim 10, wherein the first conduit is perpendicular to the second conduit.

12. The liquid-cooling device having the liquid-gas isolation mechanism according to claim 10, wherein the first conduit is disposed adjacent to the second conduit, and the first conduit is parallel to the second conduit.

13. The liquid-cooling device having the liquid-gas isolation mechanism according to claim 10, wherein the perforation of the first baffle is on the center of the first baffle, and the perforation of the second baffle is on the center of the second baffle.

14. The liquid-cooling device having the liquid-gas isolation mechanism according to claim 10, wherein the internal conduit has a middle portion and two extension portions, the extension portions are communicated with two sides of the middle portion, and the extension portions respectively have the second openings.

15. The liquid-cooling device having the liquid-gas isolation mechanism according to claim 14, wherein the first baffle and one of the extension portions are symmetric to the second baffle and the other one of the extension portions relative to the middle portion.

16. The liquid-cooling device having the liquid-gas isolation mechanism according to claim 10, wherein each of the first baffle and the second baffle has a main body and a plurality of protrusions, the plurality of protrusions are extended from the main body, and the plurality of flow holes are defined by the main body, the plurality of protrusions and the outer wall.

17. The liquid-cooling device having the liquid-gas isolation mechanism according to claim 16, wherein each of the first baffle and the second baffle has four protrusions, and each of the protrusions has a side surface fully contacted with the outer wall.

18. The liquid-cooling device having the liquid-gas isolation mechanism according to claim 16, wherein the plurality of protrusions are disposed symmetrically with respect to the perforation.

19. The liquid-cooling device having the liquid-gas isolation mechanism according to claim 1, wherein the first conduit is penetrated through the outer wall, and the first conduit has an inlet end disposed in the tank, and wherein the liquid-gas isolation mechanism comprises:
a first baffle disposed at the first end and a second baffle disposed at the second end, wherein the flow holes at the first end are defined by the first baffle and the outer wall, and the flow holes at the second end are defined by the second baffle and the outer wall; and
a partition disposed corresponding to the inlet end, wherein a flow passage is defined by the partition and the outer wall, wherein one of the flow holes of each of the first baffle and the second baffle is communicated with the flow passage, and wherein the first conduit, the flow passage, at least one of the flow holes, and the second conduit are configured as a flow path.

20. The liquid-cooling device having the liquid-gas isolation mechanism according to claim 19, wherein the partition has a first side surface and a second side surface, and the first side surface and the second side surface are fully contacted with the outer wall.

21. The liquid-cooling device having the liquid-gas isolation mechanism according to claim 19, wherein each of the first baffle and the second baffle has a main body and a plurality of protrusions, the plurality of protrusions are extended from the main body, and the plurality of flow holes are defined by the main body, the plurality of protrusions and the outer wall.

22. The liquid-cooling device having the liquid-gas isolation mechanism according to claim 21, wherein each of the protrusions has a first body and a second body, the first body is extended from the main body, and the second body is perpendicular to the first body.

23. The liquid-cooling device having the liquid-gas isolation mechanism according to claim 21, wherein the plurality of protrusions are disposed symmetrically with respect to the main body.

24. The liquid-cooling device having the liquid-gas isolation mechanism according to claim 21, wherein the partition is connected with the main body and two of the protrusions of each of the first baffle and the second baffle.

25. The liquid-cooling device having the liquid-gas isolation mechanism according to claim 24, wherein the plurality of protrusions comprises at least two first protrusions and a plurality of second protrusions, and the partition is connected with the main body and the first protrusions of each of the first baffle and the second baffle, wherein the width of each of the first protrusions is smaller than the width of each of the second protrusions.

26. The liquid-cooling device having the liquid-gas isolation mechanism according to claim 19, further comprising an internal conduit, wherein one end of the internal conduit is communicated with the second conduit, and the other end of the internal conduit is extended into the liquid storage space.

27. The liquid-cooling device having the liquid-gas isolation mechanism according to claim 26, wherein the second conduit and the internal conduit are disposed parallel to the first conduit, and the first conduit is disposed adjacent to the second conduit.

28. The liquid-cooling device having the liquid-gas isolation mechanism according to claim 26, wherein the internal conduit is disposed perpendicular to the first conduit.

29. The liquid-cooling device having the liquid-gas isolation mechanism according to claim 28, wherein the second conduit is penetrated through the outer wall and communicated with the internal conduit, and the second conduit has a curved portion.

30. The liquid-cooling device having the liquid-gas isolation mechanism according to claim 28, wherein each of the first baffle and the second baffle has a perforation.

31. The liquid-cooling device having the liquid-gas isolation mechanism according to claim 30, wherein the second conduit is penetrated through the second end of the tank, and the internal conduit is penetrated through the perforation of the second baffle disposed at the second end.

32. A liquid-gas isolation device for separating a gas from a cooling liquid, comprising:
a tank having an outer wall defining a storage space for accommodating the cooling liquid;
a first conduit in fluid communication with the storage space and configured to guide a flow of the cooling liquid into the storage space;
a second conduit in fluid communication with the storage space and configured to guide a flow of the cooling liquid out of the storage space;
at least one baffle disposed in the liquid storage space and configured to allow a guidance of a flow of the cooling liquid in the storage space; and
a plurality of flow holes defined by the baffle and the outer wall, wherein the first conduit, at least one of the flow holes, and the second conduit are configured to provide a flow path for the cooling liquid,
and wherein the flow path extends distal to the first conduit and the second conduit to effect the separation of the gas from the cooling liquid when the cooling liquid flows via the flow path.
